(19) United States
(12) Patent Application Publication
(10) Pub. No.: US 2019/0298596 A1
(43) Pub. Date: Oct. 3, 2019

(54) WHEELCHAIR ASSEMBLY

(71) Applicant: Robert Herrmann, Lynchburg, VA (US)

(72) Inventor: Robert Herrmann, Lynchburg, VA (US)

(21) Appl. No.: 16/366,893

(22) Filed: Mar. 27, 2019

Related U.S. Application Data
(60) Provisional application No. 62/648,903, filed on Mar. 27, 2018.

(51) Int. Cl. A61G 5/12

(52) U.S. Cl. CPC A61G 5/122; A61G 5/128; A61G 5/125

(57) ABSTRACT

An improved wheelchair assembly structured and arrange to equip a standard manual wheelchair with larger front wheels giving the user added leverage and control when maneuvering their chair.

### CROSS-REFERENCE TO RELATED APPLICATION

The present application is related to and claims priority from prior provisional application Ser. No. 62/648,903, filed Mar. 27, 2018 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of wheelchair devices and more specifically relates to an improved wheelchair assembly structured and arrange to equip a standard manual wheelchair with larger front wheels giving the user added leverage and control when maneuvering their chair.

### 2. DESCRIPTION OF THE RELATED ART

According to the Disability Statistics Center of the University of California at San Francisco, more than 13 million people currently use an “assistive technology device”; and that of the 1.7 million who use wheelchairs or scooters, the vast majority (90 percent, or 1.5 million persons) use manual wheelchairs.

A wheelchair is a chair with wheels, used when walking is difficult or impossible due to illness, injury, or disability. Wheelchairs come in a wide variety of formats to meet the specific needs of their users. They may include specialized seating adaptions, individualized controls, and may be specific to particular activities, as seen with sports wheelchairs and beach wheelchairs. The most widely recognized distinction is between powered wheelchairs (“powerchairs”), where propulsion is provided by batteries and electric motors, and manually propelled wheelchairs, where the propulsive force is provided either by the wheelchair user/occupant pushing the wheelchair by hand (“self-propelled”), or by an attendant pushing from the rear (“attendant propelled”).

While a manual wheelchair does give its user independent mobility, this does not necessarily mean that maneuvering a manual wheelchair—with its small-diameter front wheels—is easy. Therefore, a need exists for an improved wheelchair device to correct this design deficiency, and offer wheelchair users a more user-friendly, more easily maneuverable chair.

Various attempts have been made to solve problems found in wheelchair device art. Among these are found in: U.S. Pat. No. 5,507,513 to Bryan T. Peters et al.; U.S. Pat. No. 8,152,192 to Patrick S. Dougherty; and U.S. Pat. No. 4,545,593 to Jeffrey R. Farnam. This prior art is representative of improved wheelchair devices.

Ideally, an improved wheelchair assembly should be user-friendly and safe in-use and yet would operate reliably and be manufactured at a modest expense. Thus, a need exists for an improved wheelchair assembly structured and arrange to equip a standard manual wheelchair with larger front wheels giving the user added leverage and control when maneuvering their chair and to avoid the above-mentioned problems.

### BRIEF SUMMARY OF THE INVENTION

In view of the foregoing disadvantages inherent in the known wheelchair device art, the present invention provides a novel improved wheelchair assembly. The general purpose of the present invention, which will be described subsequently in greater detail is to provide an improved wheelchair assembly structured and arrange to equip a standard manual wheelchair with larger front wheels giving the user added leverage and control when maneuvering their chair.

An improved wheelchair assembly comprising: a main frame, a seat; a backrest; two spaced footplates; two spaced rear wheels; two spaced caster forks; and two spaced front castor wheels. The main frame includes: two spaced armrests, two spaced hand grips, and two spaced footplate bars.

Wherein the seat is attached to the frame. Wherein the backrest is attached to the frame. Wherein the two spaced footplates are attached to respective two spaced footplate bars. Wherein the two spaced rear wheels are attached to the frame. Wherein the two spaced caster forks are attached to the frame.

Wherein the two spaced front castor wheels are rotatably attached to respective two spaced caster forks. Wherein the two spaced caster forks are adapted to releasably and rotatably hold front castor wheels having a diameter of 9 inches. Wherein the two spaced front castor wheels are formed having a diameter of 9 inches. Wherein the front castor wheels are adapted to give a person manipulating the improved wheelchair assembly additional leverage and added maneuverability to manipulate the improved wheelchair assembly with less effort as compared to known wheelchair assemblies having front castor wheels having a diameter of 8 inches.

The present invention holds significant improvements and serves as an Improved Wheelchair Assembly. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an Improved Wheelchair Assembly, constructed and operative according to the teachings of the present invention.

FIG. 1 shows a perspective view illustrating an Improved Wheelchair Assembly according to an embodiment of the present invention.

FIG. 2 is a perspective view illustrating two spaced footplates pivotally connected to respective two spaced footplate bars of the Improved Wheelchair Assembly according to an embodiment of the present invention of FIG. 1.

FIG. 3 is a perspective view illustrating the Improved Wheelchair Assembly in an in-use condition according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a wheelchair device and more particularly to a wheelchair assembly structured and arrange to equip a standard manual wheelchair with larger front wheels giving the user added leverage and control when maneuvering their chair.

Generally speaking, the Improved Wheelchair Assembly comprises a specially designed simple improvement upon the existing design of manual wheelchairs, in which the front wheels would be enlarged to a diameter of 9 inches from the now standard diameter of 8 inches.

This design enhancement could be incorporated into the design and production of new manual wheelchairs, or—in existing chairs equipped with pin-locking, removable front-wheel assemblies—produced and sold as an add-on, aftermarket upgrade for existing wheelchairs. The enlarged front wheels would give the wheelchair user additional leverage and added maneuverability, with less effort—and the Improved Wheelchair Assembly would also include a slightly lengthened foot-plate bar for additional stability.

Thus, although simple in conception and easily described, the Improved Wheelchair Assembly would represent a profound improvement in wheelchair design, greatly enhancing the wheelchair-user's ability to maneuver and navigate their chair—and improving their own sense (and possession) of independent mobility. As such, the Improved Wheelchair Assembly should find a wide and enthusiastic market reception, first among those firms which produce manual wheelchairs, and then among the millions of consumers—both within the United States and around the world—who depend on a manual wheelchair for mobility.

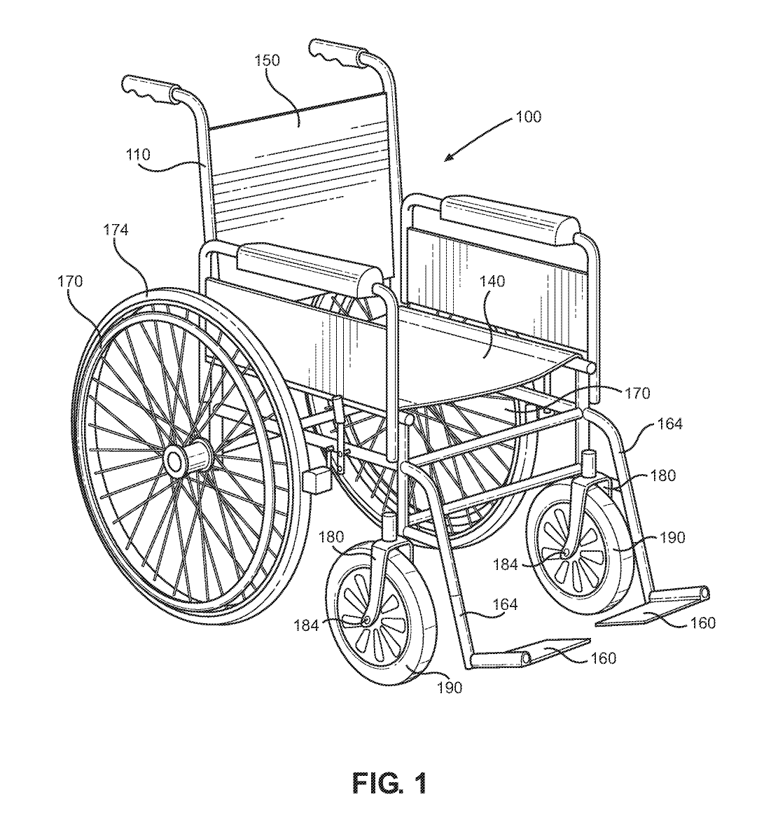

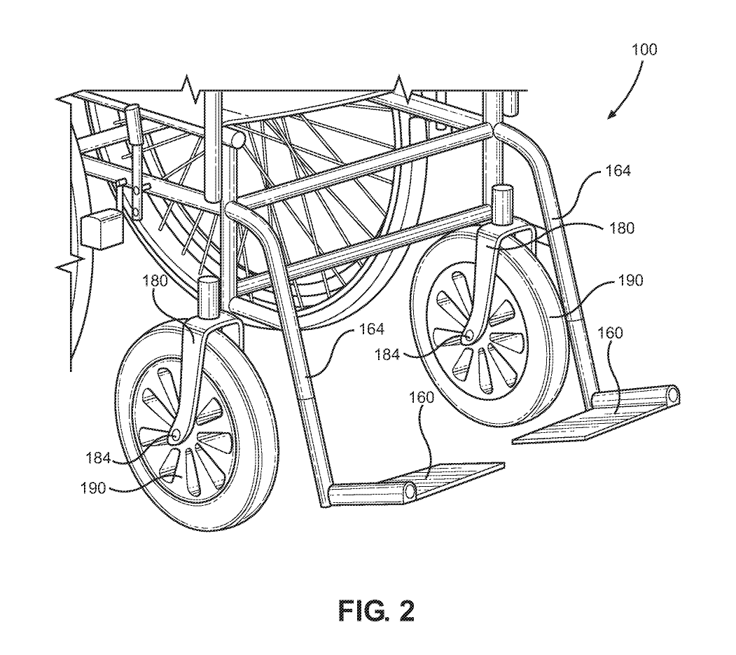

Referring to the drawings by numerals of reference there is shown in FIGS. 1-3, perspective views illustrating improved wheelchair assembly 100 according to an embodiment of the present invention.

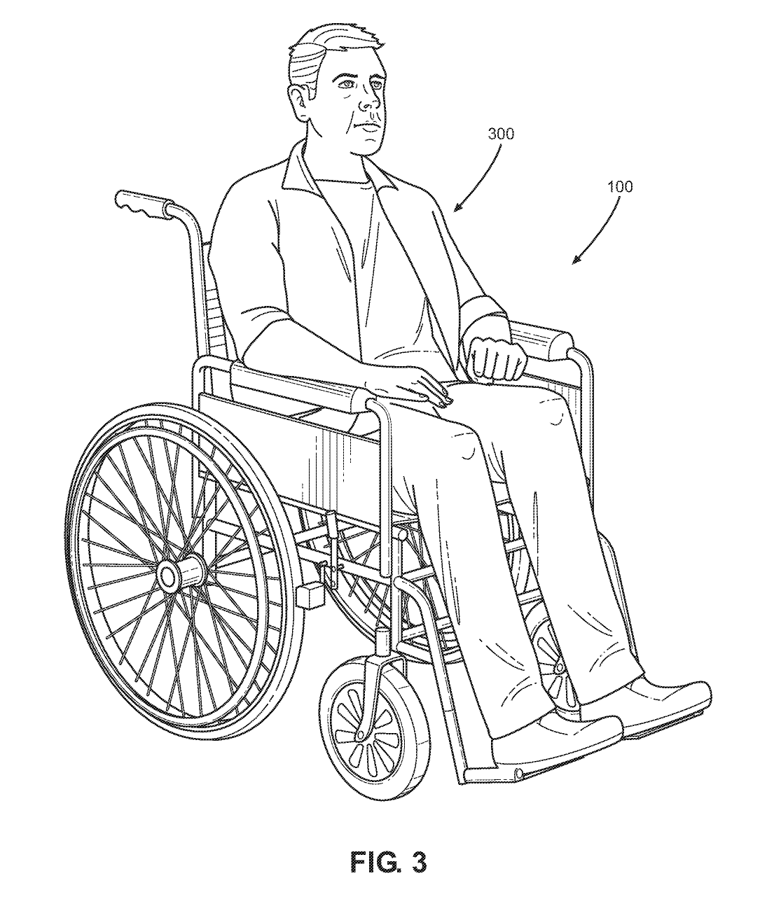

Improved wheelchair assembly 100 comprising: main frame 110, seat 140; backrest 150; two spaced footplates 160; two spaced rear wheels 170; two spaced caster forks 180; and two spaced front castor wheels 190. Main frame 110 includes: two spaced armrests 116, two spaced hand grips 124, and two spaced footplate bars 164.

Wherein seat 140 is attached to frame 110. Wherein backrest 150 is attached to frame 110. Wherein two spaced footplates 160 are attached to respective two spaced footplate bars 164. Wherein two spaced footplates 160 are pivotally connected to respective two spaced footplate bars 164. Wherein two spaced footplate bars 164 are formed having a length greater than known wheelchair assemblies 100 and are adapted to provide increased stability to improved wheelchair assembly 100 as compared to known wheelchair assemblies 100.

Wherein two spaced rear wheels 170 are attached to frame 110. Wherein two spaced caster forks 180 are attached to frame 110. Wherein two spaced front castor wheels 190 are rotatably attached to respective two spaced caster forks 180. Wherein each of two spaced rear wheels 170 include push ring 174 attached thereto. Wherein two spaced caster forks 180 are adapted to releasably and rotatably hold front castor wheels 190 having a diameter of 9 inches. Wherein two spaced caster forks 180 are pivotally attached to frame 110. Wherein two spaced caster forks 180 are removably attached to frame 110. Wherein two spaced caster forks 180 are removably attached to frame 110 via pin-locking assembly 184.

Wherein said two spaced front castor wheels 190 are formed having a diameter of 9 inches. Wherein front castor wheels 190 are adapted to give a person manipulating improved wheelchair assembly 100 additional leverage and added maneuverability to manipulate improved wheelchair assembly 100 with less effort as compared to known wheelchair assemblies 100 having front castor wheels 190 having a diameter of 8 inches as shown in in-use condition 300 of FIG. 3.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved wheelchair assembly comprising:
a main frame including;
two spaced armrests;
two spaced hand grips; and
two spaced footplate bars;
a seat;
wherein said seat is attached to said frame;
a backrest;
wherein said backrest is attached to said frame;
two spaced footplates;
wherein said two spaced footplates are attached to respective said two spaced footplate bars;
two spaced rear wheels;
wherein said two spaced rear wheels are attached to said frame;
two spaced caster forks;
wherein said two spaced caster forks are attached to said frame; and
two spaced front castor wheels;
wherein said two spaced front castor wheels are rotatably attached to respective said two spaced caster forks;
wherein said two spaced caster forks are adapted to releasably and rotatably hold front castor wheels having a diameter of 9 inches;
wherein said two spaced front castor wheels are formed having a diameter of 9 inches;
wherein said front castor wheels are adapted to give a person manipulating said improved wheelchair assembly additional leverage and added maneuverability to manipulate said improved wheelchair assembly with less effort as compared to known wheelchair assemblies having front castor wheels having a diameter of 8 inches.

2. The improved wheelchair assembly of claim 1, wherein said two spaced caster forks are pivotally attached to said frame.

3. The improved wheelchair assembly of claim 1, wherein said two spaced footplates are pivotally connected to respective said two spaced footplate bars.

4. The improved wheelchair assembly of claim 1, wherein each of said two spaced rear wheels include a push ring attached thereto.

5. The improved wheelchair assembly of claim 1, wherein said two spaced footplate bars are formed having a length greater than known wheelchair assemblies and are adapted to provide increased stability to said improved wheelchair assembly as compared to said known wheelchair assemblies.

6. The improved wheelchair assembly of claim 2, wherein said two spaced caster forks are removably attached to said frame.

7. The improved wheelchair assembly of claim 6, wherein said two spaced caster forks are removably attached to said frame via a pin-locking assembly.
